(19) United States
(12) Patent Application Publication
(10) Pub. No.: US 2005/0280542 A1
(43) Pub. Date: Dec. 22, 2005

(54) Method for embedding RFID tag in object

(76) Inventor: Yeng-Bao Shieh, Kaohsiung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/874,068

(22) Filed: Jun. 22, 2004

(51) Int. Cl. G08B 13/14

(52) U.S. Cl. 340/572.8

(57) ABSTRACT

A method for embedding a tag in an object includes placing a tag in a mold defining a cavity for forming an object, holding the tag on a face delimiting the cavity, and forming the object in the cavity, with the tag being embedded in the object. The tag includes an inner layer with an outer face, an outer layer formed on the outer face of the inner layer, and an integrated circuit mounted on the outer face of the inner layer and covered and thus protected by the outer layer, with an antenna device being electrically coupled to the integrated circuit, and with the antenna device being also covered and thus protected by the outer layer. The outer layer is made of non-metal material to allow transmission of signals.

### BACKGROUND OF THE INVENTION

1. Field of the Invention

The present invention relates to a method for embedding a radio frequency identification (RFID) tag in an object. In particular, the present invention relates to a method for embedding a radio frequency identification (RFID) tag in an object such as a pass, a card, a container, etc.

2. Description of the Related Art

Radio frequency identification (RFID) system has been widely used in many areas, such as access control, baggage identification of aerial transport, material handling, waste control, anti-theft in supermarkets, toll management on highways, tracing of wild lives, etc. A typical radio frequency identification system comprises a tag (or transponder) and a reader, with an antenna means coupled to the tag.

In an application of material handing, the tag is bonded or attached to an outer surface of an object (such as a commodity) to give this object a specific identity. When the tag is within an operational area of the reader, a transceiver in the reader sends a signal to activate an integrated circuit in the tag. In response, the tag sends signals containing digital message relating to the identity of the object to the transceiver of the reader. The digital message relating to the identity of the object is passed by the transceiver to an integrated circuit in the reader. The digital message may contain information similar to a barcode for the object as well as other information. Unlike the conventional barcode readers, the RFID system requires no light during operation and without contact with the object and allows reading while the object is moving at high speed. Further, the RFID system may handle many objects at one time and write handling information into the integrated circuit of the tag for subsequent handling. Further, the tag is more durable than barcodes printed on objects. Further, the tag can be hidden in the object. Further, the tag allows tracing and provides an anti-theft function. Thus, the conventional barcodes and barcode readers have gradually been replaced by the RFID system.

However, the tag is exposed and thus apt to be damaged due to impingement. Further, the appearance of the object is adversely affected by the protruded tag. A solution to this problem is forming a groove in a face of the object and mounting the tag into the groove, with an outer face of the tag being flush with the face of the object. However, damage to the tag is still possible, and formation of the groove is troublesome.

### SUMMARY OF THE INVENTION

In accordance with an aspect of the present invention, a method for embedding a radio frequency identification (RFID) tag in an object includes placing a radio frequency identification (RFID) tag in a mold defining a cavity for forming an object, holding the tag on a face delimiting the cavity, and forming the object in the cavity, with the tag being embedded in the object.

The tag includes an inner layer with an outer face, an outer layer formed on the outer face of the inner layer, and an integrated circuit mounted on the outer face of the inner layer and covered and thus protected by the outer layer, with an antenna means being electrically coupled to the integrated circuit, and with the antenna means being also covered and thus protected by the outer layer. Thus, the tag is well protected and provides an aesthetically pleasing appearance of the object while providing the required function. The outer layer is made of non-metal material to allow transmission of signals.

Other objects, advantages, and novel features of the invention will become more apparent from the following detailed description when taken in conjunction with the accompanying drawings.

### BRIEF DESCRIPTION OF THE DRAWINGS

FIG. 1 is a flowchart illustrating a method for embedding a radio frequency identification (RFID) tag in an object in accordance with the present invention.

FIG. 2 is a sectional view, in an enlarged scale, of a tag in accordance with the present invention.

FIG. 3 is a top view of the tag in accordance with the present invention.

FIG. 4 is a sectional view showing a product manufactured by the method in accordance with the present invention.

FIG. 5 is a sectional view showing another product manufactured by the method in accordance with the present invention.

FIG. 6 is a sectional view showing a further product manufactured by the method in accordance with the present invention.

FIG. 7 is a sectional view showing a mold for manufacturing the product in FIG. 4.

FIG. 8 is a sectional view showing a mold for manufacturing the product in FIG. 5.

FIG. 9 is a sectional view showing a mold for manufacturing the product in FIG. 6.

### DETAILED DESCRIPTION OF THE PREFERRED EMBODIMENTS

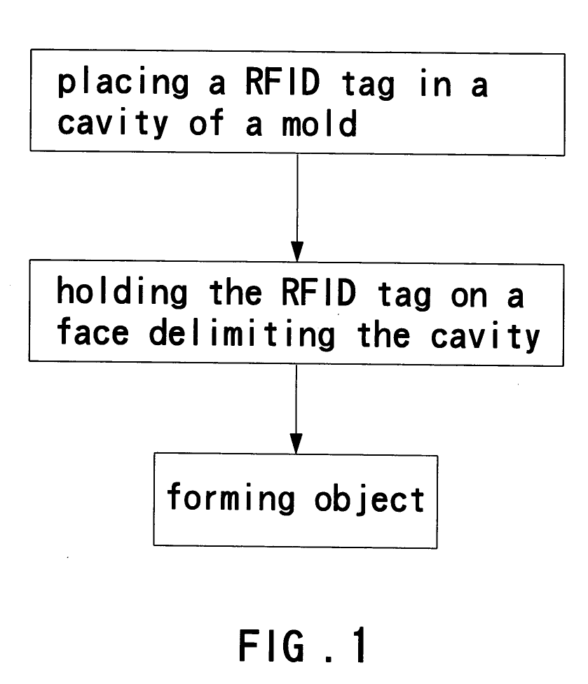

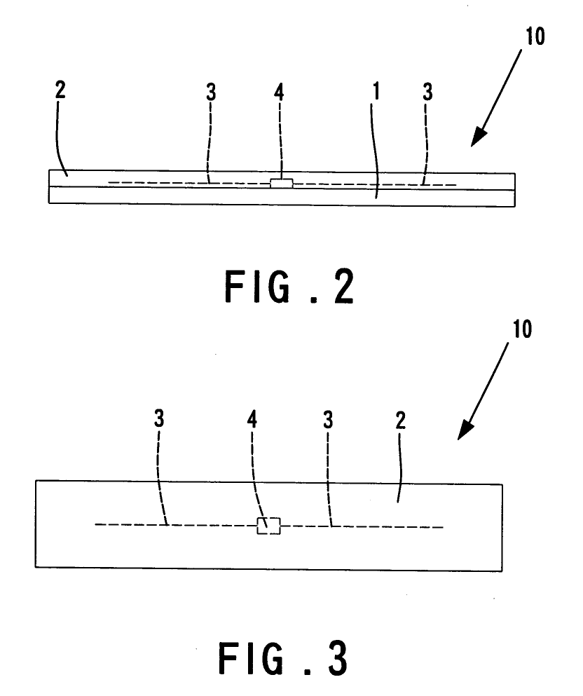

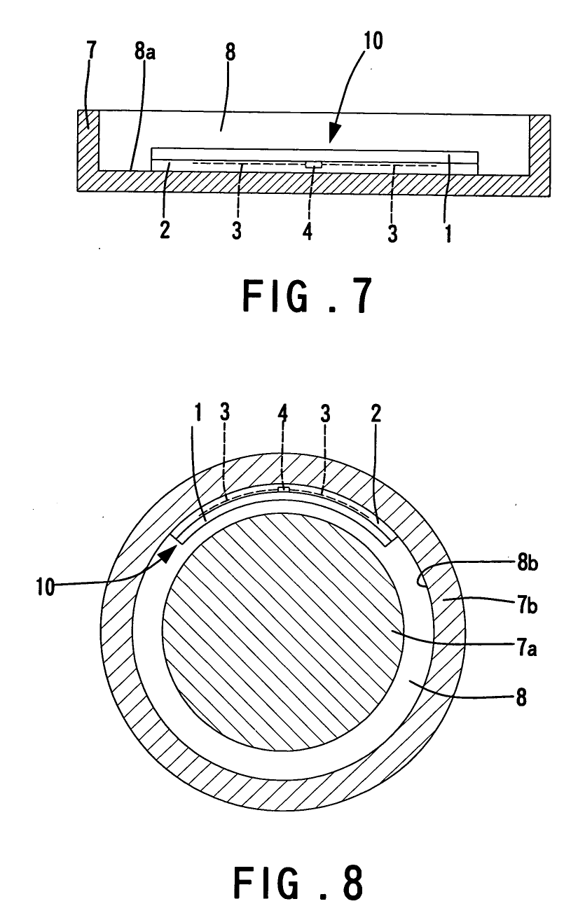

Referring to FIG. 1, a method for embedding a radio frequency identification (RFID) tag in an object in accordance with the present invention comprises placing a radio frequency identification (RFID) tag 10 in a mold 7 (FIG. 7) for forming an object such as a card or a container. As illustrated in FIGS. 2 and 3, the tag 10 comprises an inner layer 1, an outer layer (protective layer) 2 formed on an outer face of the inner layer 1, and an integrated circuit (IC) 4 mounted on the outer face of the inner layer 1 and covered and thus protected by the outer layer 2, with an antenna means (two antennae 3 in this embodiment) being electrically coupled to the IC 4. The antennae 3 are also covered and thus protected by the outer layer 2. The inner layer 1 may be made from any suitable material (metal or non-metal). The outer layer 2 is made from non-metal material to allow transmission of signals. Further, the outer layer 2 protects the tag 10 from being damaged. The outer layer 2 may be made of plastics, rubbers, etc. The antennae 3 can be mounted to or printed on the outer face of the inner layer 1.

As illustrated in FIG. 7, the mold 7 defines a cavity 8 for forming the object 5. The tag 10 is held on a face 8a delimiting the cavity 8. In this embodiment, the tag 10 is held on the face 8a delimiting the cavity 8 by vacuum or static electricity. Molten material (such as plastic or glass) is filled into the cavity 8 defined in the mold 7. After cooling and hardening of the material, an object is formed, with the tag 10 being embedded in the object. The mold for forming an object by molding injection or extrusion and holding by vacuum or static electricity are conventional and therefore not described in detail. Further, formation of the object 5 is not limited to molding or extrusion. Other suitable methods for forming objects can be adopted.

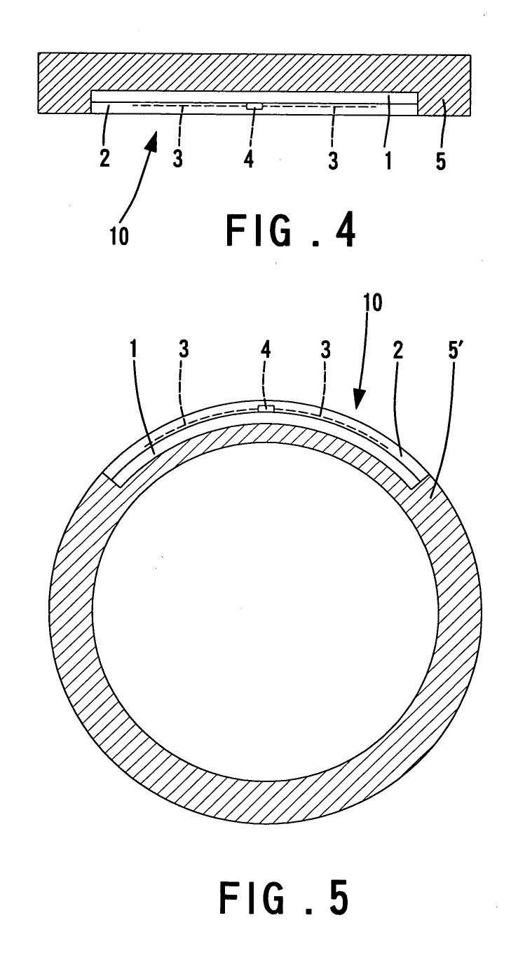

Referring to FIG. 4, the object may be a card (such as a passage) 5. After formation, the tag 10 is embedded in a face of the card 5, with an outer face of the outer layer 2 being flushed with the face of the card 5. Formation of the card 5 causes no damage to the tag 10. The second layer 2 may be transparent or non-transparent. In a case that the second layer 2 is non-transparent, intentional damage to the tag 10 can be avoided. The tag 10 can be recycled whenever appropriate. In this case, the second layer 2 is transparent to indicate the position. The card 5 can as a whole attached to, e.g., a large container to provide an identifying function while preventing damage to the tag 10. In an application on a pallet, the pallet may include a groove for receiving the tag 10.

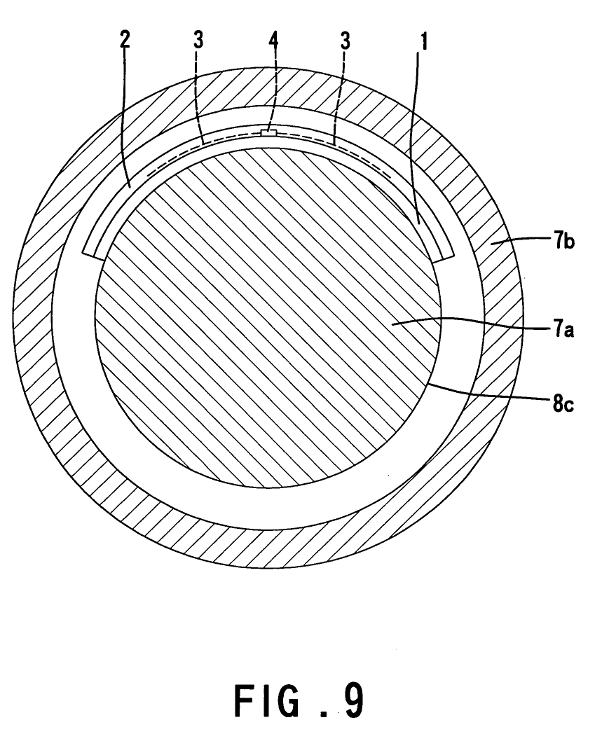

Referring to FIG. 5, the object may be a container 5′ such as a plastic or glass container. In this embodiment, the mold includes an outer mold part 7b and an inner mold part 7a, delimiting a cavity 8 therebetween, as illustrated in FIG. 8. During formation, the tag 10 is held on an inner periphery 8b of the outer mold part 7b of the mold. After formation, the tag 10 is embedded in an outer portion of the container 5′, with an outer face of the outer layer 2 of the tag 10 being flushed with the outer face of the container 5′. Formation of the container 5′ causes no damage to the tag 10. Similarly, the second layer 2 may be transparent or non-transparent.

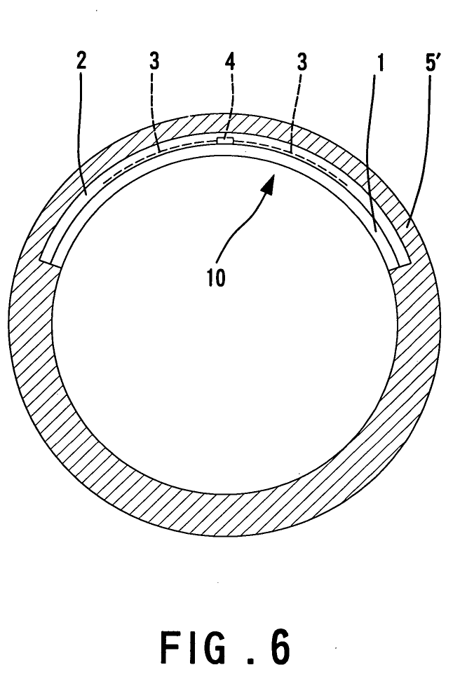

FIG. 6 shows a modified example of the embodiment in FIG. 5. During formation, the tag 10 is held on an outer periphery 8c of the inner mold part 7a of the mold, as shown in FIG. 9. After formation, the tag 10 is embedded in an inner portion of the container 5′, providing further protection to the tag 10.

The object with a tag 10 embedded therein by the method in accordance with the present invention is not limited in shape. Namely, the object may have any desired shape. Function of the tag 10 is conventional and therefore not described in detail to avoid redundancy.

Thus, the tag 10 is well protected and provides an aesthetically pleasing appearance of the object while providing the required function.

Although specific embodiments have been illustrated and described, numerous modifications and variations are still possible without departing from the essence of the invention. The scope of the invention is limited by the accompanying claims.

1. A method for embedding a radio frequency identification tag in an object, comprising:
placing a radio frequency identification tag in a mold defining a cavity for forming an object;
holding the tag on a face delimiting the cavity; and
forming the object in the cavity, with the tag being embedded in the object.

2. The method as claimed in claim 1, with the tag including a protective layer having an outer face that is flush with an outer face of the object.

3. The method as claimed in claim 1, with the mold including an inner mold part and an outer mold part, with the tag being held in an inner periphery of the outer mold part in the step of holding the tag on a face delimiting the cavity.

4. The method as claimed in claim 1, with the mold including an inner mold part and an outer mold part, with the tag being held in an outer periphery of the inner mold part in the step of holding the tag on a face delimiting the cavity.

5. The method as claimed in claim 1, with the tag being held in place by one of vacuum and static electricity in the step of holding the tag on a face delimiting the cavity.

6. The method as claimed in claim 2, with the protective layer being one of transparent and non-transparent.

7. The method as claimed in claim 3, with the tag including a protective layer having an outer face that is flush with an outer face of the object.

8. The method as claimed in claim 1, with the tag including an inner layer with an outer face, an outer layer formed on the outer face of the inner layer, and an integrated circuit mounted on the outer face of the inner layer and covered and thus protected by the outer layer, with an antenna means being electrically coupled to the integrated circuit, and with the antenna means being also covered and thus protected by the outer layer.

9. The method as claimed in claim 8, with the mold including an inner mold part and an outer mold part, with the tag being held in an inner periphery of the outer mold part in the step of holding the tag on a face delimiting the cavity.

10. The method as claimed in claim 8, with the mold including an inner mold part and an outer mold part, with the tag being held in an outer periphery of the inner mold part in the step of holding the tag on a face delimiting the cavity.

11. The method as claimed in claim 8, with the tag being held in place by one of vacuum and static electricity in the step of holding the tag on a face delimiting the cavity.

12. The method as claimed in claim 8, with the protective layer being one of transparent and non-transparent.

13. The method as claimed in claim 9, with the outer layer of the tag including an outer face that is flush with an outer face of the object.

14. The method as claimed in claim 2, with the protective layer of the tag being made of non-metal material.

15. The method as claimed in claim 7, with the protective layer of the tag being made of non-metal material.

16. The method as claimed in claim 8, with the outer layer of the tag being made of non-metal material.

17. The method as claimed in claim 9, with the outer layer of the tag being made of non-metal material.

18. The method as claimed in claim 10, with the outer layer of the tag being made of non-metal material.

19. The method as claimed in claim 11, with the outer layer of the tag being made of non-metal material.

20. The method as claimed in claim 12, with the outer layer of the tag being made of non-metal material.
